(19) United States
(12) Patent Application Publication
(10) Pub. No.: US 2026/0141236 A1
(43) Pub. Date: May 21, 2026

(54) Learning-Based Determination of Operating State of a Production Process

(71) Applicant: Siemens Aktiengesellschaft, Muenchen (DE)

(72) Inventors: Adrian Caspari, Karlsruhe (DE); Thomas Bierweiler, Karlsruhe (DE); Daniel Labisch, Karlsruhe (DE); Andreas Sachs, Karlsruhe (DE); Sven Kempf, Karlsruhe (DE); Markus Rölle, Karlsruhe (DE)

(21) Appl. No.: 19/389,230

(22) Filed: Nov. 14, 2025

(30) Foreign Application Priority Data
Nov. 18, 2024 (LU) LU508949

(51) Int. Cl. G06N 3/08; G06N 3/045

(52) U.S. Cl. CPC G06N 3/08; G06N 3/045

(57) ABSTRACT

A computer-implemented method, a computer-implemented apparatus, a system and a computer program product for determining an operating state of an industrial production process, includes providing process data, which is associated with the production process, to at least one first trained neural network, wherein the first neural network comprises at least one anomaly identification model and the process data is provided to each at least one anomaly identification model as well as determining, at least partially based on the first trained neural network, whether the process data is assignable to a predefined operating state and providing a first indicator, which is indicative of whether the process data is assignable to an operating state.

### BACKGROUND OF THE INVENTION

1. Field of the Invention

The present invention relates to a computer-implemented method, a computer-implemented apparatus, a system, a computer program product for determining an operating state of an industrial production process and a corresponding training method for a neural network.

### 2. Description of the Related Art

Modern industrial production processes usually represent a complex succession of individual steps whose accurate monitoring over time can be regarded as important in order to be able to enable an optimized manufacturing cycle. In particular, it can be regarded as important to determine and characterize a specific operating state (i.e., a state that can describe the manufacturing process in its entirety during a cycle).

Industrial production processes can comprise a succession of physical and/or chemical reactions. This succession of the physical and/or chemical reactions that thus results can ultimately define an operating state that can dynamically change.

Methods that are frequently used for determining a current operating state do not usually enable efficient and/or sufficiently reliable determination of a corresponding operating state. Consequently, a sufficient characterization or sufficient monitoring of production process over time cannot be ensured under all circumstances.

Without the possibility of a reliable and accurate description of an operating state, the problem of inadequate determination of whether a desired target state has already been attained arises for a production process, and this can correspondingly result in potential delays, errors and a suboptimal performance. Even if determination of an operating state seems possible manually, via an (operator) action of an operator, this need for a manual (operator) action nevertheless limits the productivity to be attained and increases the risk of human error.

A further uncertainty can then result, for example, if a production process is in an operating state to which no operating state which is already known can be assigned. In such a case, it is usually not possible to ensure a sufficiently accurate determination of an operating state.

The problem of determining operating states has until now usually been solved in that a (deterministic) sequence-based completion of operating states has been assumed. In such a case, the production process follows the adoption of predefined sequences (for example, operating states), with an end state being determined based on a finding that particular (execution) steps have been concluded. It was thus possible, for example, that completion of a production process was begun, for example, with a predefined state and from there was transferred into other states via predefined orders of completion. However, this procedure is also subject to the disadvantage of enabling the accurate determination of a current operating state because only predefined sequences are drawn on without taking real-time feedback into account. This also ignores, in particular, an omnipresence of disruptions in the field of process automation.

Alternatively, efforts have also been pursued in which operating states were determined based on strictly predefined definitions (hardcoded), such as within the meaning of strictly defined ranges for specific parameters. While an approach of this kind enables identification of a state level (level of state), it is thus nevertheless limited by its inflexibility and inability to adapt to changing process conditions. Predefined definitions cannot cover all possible eventualities, and this can result in corresponding errors and inaccuracy in determining operating states.

Defining individual values of a vector can be problematic, in particular in the higher dimensional space. In a scenario of this kind, the ratios/correlations to one another are usually relevant. In some cases, these may be calculated or mapped as additional dimensions in the state space and thereby be reduced in their dimension

However, these existing solutions have proven to be insufficient and too inaccurate overall for determining operating states based on process data and tracking them over time. The limitations of sequence-based cycles and strictly predefined state definitions have made a more advanced and intelligent system necessary that can also adapt to dynamic process conditions, and require real-time feedback for precise state detection and process automation based on available process data.

In other cases, it can be necessary to know about a possible succession of different operating states. In some cases, this can already fail because no further courses of action are enabled when an unknown state is identified.

In such a case, it can be necessary to draw on the experience of users to determine corresponding states and to navigate through the succession thereof as well as reach end state or target state. In this regard, operators can frequently draw on procedural operating instructions or documents to be able to understand an underlying process cycle and to be able to select from among available subsequent states. However, an approach of this kind can prove to be time-intensive, susceptible to faults and inefficient (primarily in complex systems with a large number of states and transitions). Some automation possibilities can enable a fundamental management and visualization of the process states but often fail due to the lack of comprehensive support for identifying the process states (i.e., determining process states that are available in principle) and determining a next state in the case of undefined states which exist.

The industry standards ISA-106 and ISA-88 can contribute to the definition of a state-based procedure because they can contribute guidelines and best-practice solutions to the design and implementation of state-based control systems.

Systems are known that are designed for the definition or characterization for state-based methods, such as Distributed Control system (DCS). A DCS is an automation system frequently used in the process industry, which can be configured such that it supports state-based control strategies. As a rule, DCS platforms offer functions for monitoring process states, for managing transitions and for executing control actions on the basis of procedural requirements. Further, batch control systems can be considered, with these being taken to mean batch control systems that are frequently based on the ISA-88 standard, and are used in industries that comprise batch production processes. These systems enable the management and control of complex methods with a plurality of states and transitions. While continuous processes and possible transitions from one virtually static to a different virtually static state are usually the focus of State Based Control ISA106, typical batch processes are characterized by a large number of different states after each individual process step. In some cases, long-term archiving systems (for process data) or historians can be used. Process historians are data management systems that collect and store process data. They can be used to track and document the state-based operation of processes in order to thus (subsequently) obtain insights into the historical development and behavior of the system. In some cases, Advanced Process Control (APC) systems can also be used. APC systems use advanced algorithms and models to optimize the process performance and control. These systems can incorporate strategies for process management to improve the process efficiency and stability. Further, it can be possible to implement Manufacturing Execution systems (MES). MES platforms offer real-time transparency and control of the manufacturing cycles. They can include state-based control functions in order to manage and track the execution of methods and work cycles.

### SUMMARY OF THE INVENTION

In view of the foregoing, it is therefore an object of the invention to provide a computer-implemented method for improving the determination of an operating state.

This and other objects and advantages are achieved in accordance with the invention by a computer-implemented method for training a first neural network to identify an operating state of an industrial production process. The method comprises defining the at least one operating state, determining at least one time interval in which the industrial production process finds itself in the operating state which is to be identified, providing a first assignment of process data, which is associated with the production process, for the operating state that is to be identified and that is active during the time interval. Further, the computer-implemented method can comprise training, based on the provided first assignment, a first neural network, where the first neural network comprises at least one anomaly identification model and wherein the neural network is trained, based on the at least one anomaly identification model, to perform an assignment of process data, which is associated with the production process, for an operating state which is active at a particular time interval.

The industrial production process can comprise a successive sequence of operating states. In some cases, the operating states, in addition to a (predetermined) successive sequence, can also be branched (with the branches being, for example, conditionally retrieved).

Defining an operating state can comprise establishing values for the process data, so, if a set of process values, which are associated with the process data, is within a target corridor, it is possible to determine that the industrial production process has assumed a determined operating state associated with the relevant process data.

In the present context, process data can be taken to mean all data that can be captured during a run-through of a production process. This can be, for example, sensor data and/or calculated data (for example, derived at least partially from sensor data). This can comprise, for example, capturing temperature data, pressure data, weight data, speed data, throughput data and/or other suitable data. In some cases, offline data can also be used, which denotes, for example, properties of pre-products that have been used. In some cases, the process data can comprise a voltage and/or a current.

The time interval can be selected, for example, up to 10 seconds, up to 30 seconds, up to 1 minute, up to 5 minutes, up to 30 minutes, up to 1 hour, up to 5 hours, up to 12 hours, up to 24 hours or longer than 1 day. The at least one time interval can comprise more than one time interval, such as at least two time intervals, and can be provided such that its length is always constant. In some cases, the length of the at least one time interval can change over time.

In this way, a training method can be efficiently provided for a first neural network, so determination can subsequently be enabled with the trained first neural network as to whether provided process data can, in principle, be assigned to a (predefined or already known) operating state. This can enable improved monitoring of an industrial production process. In particular, this can enable determination of a current operating state without having to know or take into account a pre-history of the current operating state. This can be, in particular, a targeted and efficient jump to an operating state, for example, as part of a sequential succession of operating states.

In accordance with one embodiment, the operating state can be associated with the production of a particular product or with an initial operating state.

Here, an operating state can be taken to mean a cycle step of an industrial production process. A cycle step can be distinguished by a specific action or by waiting (i.e., by a period in which no specific action associated with a production process occurs). In other words, the operating state can be associated with the production of a particular product. In such a case, cited by way of example, the production process can be based, for example, on the manufacture of a substance C. The manufacture can comprise, for example, the operating states “providing a first initial substance”, “providing a second initial substance” and “mixing the first initial substance with the second initial substance”, whereby substance C can be formed by the mixing. The respective operating states can be represented by specific manifestations of the values of process data.

An initial operating state can be taken to mean that operating state of an industrial production process that is assumed as a first operating state when the industrial production process is initially started. In some examples, the initial operating state can comprise an initialization of the industrial production process. The initialization can comprise, for example, setting the apparatuses that are to be used during the course of the industrial production process to a predetermined (initial) start value (such as a fill level, a temperature, a pressure, and/or a flow rate).

This can contribute to a deterministic mapping of the industrial production process and therewith support improved monitoring of the sequence of an industrial production process.

In accordance with a further embodiment, for each operating state which is to be identified, the first neural network can comprise one anomaly identification model respectively and each operating state which is to be identified can be assigned to one anomaly identification model respectively, which identifies the operating state which is to be identified as anomaly-free.

Here, an anomaly identification model can be taken to mean a model (for example, within the meaning of at least one neural network) based on at least one artificial intelligence, which was trained to identify deviations (that is to say, anomalies) from at least one target state.

In this way, identification of an operating state can be efficiently and reliably enabled for a large number of operating states and thus monitoring of an industrial production process can be provided in an improved manner.

In accordance with a further embodiment, the training can comprise training each anomaly identification model, so each anomaly identification model identifies the operating state assigned to it respectively as anomaly-free and identifies other operating states different from the assigned operating state as having an anomaly.

The anomaly identification model can be trained such that it identifies an operating state as anomaly-free if the operating state that is to be identified corresponds to the operating state for which the anomaly identification model was trained. In such a case, the operating state, which is to be identified by the anomaly identification model, can be taken to mean a target state for the anomaly identification model. The at least one target state can have been trained based on good data, with it being possible for the good data to comprise process data that can be associated with a determined operating state which, from the perspective of the anomaly identification model, is to be characterized as “good” or as “not abnormal”.

The operating state can be identified, for example, as anomaly-free if the at least one anomaly identification model does not find any deviation of the captured process data from an assignment of process data to an operating state for which the anomaly identification model was trained. If, by contrast, a deviation (for example, as an outlier, new, hitherto unknown feature, etc.) is found with respect to the assignment of process data to an operating state, via which the anomaly identification model was trained, then the existence of an anomaly can be inferred.

In this way, a training method can be provided that can be used for improved determination of the existence of an operating state.

In accordance with a further embodiment, the computer-implemented method can also comprise providing a second neural network, which comprises a classifier, with a second assignment of process data for one operating state respectively, as well as training, based on the provided second assignment, of the second neural network, where the second neural network is trained to assign process data to an operating state.

The second assignment of process data can be provided such that the process data can be associated, preferably exclusively, with an operating state.

In this way, apart from the determination that captured process data can, in principle, be assigned to an operating state (for example, based on a determination that no anomaly exists), additionally an assignment of the process data to a determined operating state can also be enabled for the second neural network. This can contribute to a further improvement in monitoring at least one operating state of an industrial production process.

In a second alternative embodiment, a computer-implemented method for determining an operating state of an industrial production process is provided. The computer-implemented method comprises providing process data, which is associated with the production process, to at least one first trained neural network which, as described herein, was trained, where the first neural network comprises at least one anomaly identification model and the process data is provided to each of the at least one anomaly identification model. Further, the computer-implemented method comprises determining, at least partially based on the first trained neural network, whether the process data can be assigned to a predefined operating state and providing a first indicator which is indicative of whether the process data can be assigned to an operating state.

The first indicator can be provided as a character string, as a message or in another suitable manner.

This can enable, based on a trained first neural network, improved monitoring of an industrial production process, for example, because a deterministic determination of a cycle of the industrial production process is efficiently supported.

In accordance with an embodiment, determining whether the process data can be assigned to one of the operating states also comprises determining that the process data cannot be assigned to any of the operating states if each of the at least one anomaly identification model identifies the process data as having an anomaly, or determining that the process data can be assigned to one of the operating states if one of the at least one anomaly identification model identifies the process data as anomaly-free, or determining that the process data cannot be assigned to any of the operating states if more than one anomaly identification model is provided and if at least two anomaly identification models identify the process data as anomaly-free.

In some examples, a state in which more than one anomaly identification model is provided and at least two anomaly identification models identify the process data as anomaly-free, can exist only temporarily. In some examples, a state of this kind can be taken to mean a request to perform retraining of at least one of the more than one anomaly identification model.

Determining that each of the anomaly identification models identifies the provided process data as having an anomaly, can be based on the fact that none of the anomaly identification models was trained to identify an operating state that can be associated with the provided process data. Consequently, the provided process data cannot be assigned to an operating state for which the first neural network was trained.

If an anomaly identification model identifies the provided process data as anomaly-free, then this can be based on the fact that can the relevant anomaly identification model was trained to identify the relevant operating state (based on the provided process data). In some examples, only a single anomaly identification model identifies the provided process data as being associated with an operating state.

In some examples, determining that the provided process data can be assigned to more than one operating state can be based on the fact that the provided process data is similar to a plurality of process data that was used during the course of an assignment of process data to an operating state, during training of the first neural network.

In this way, improved and, owing to the use of a plurality of anomaly identification models, statistical determining can be enabled as to whether provided process data can be assigned to an operating state, for the identification of which the first neural network was trained in advance.

In accordance with a further embodiment, the computer-implemented method can also comprise providing the process data if the process data could be assigned to an operating state, to a second neural network, comprising a classifier which was trained as described herein. Further, the computer-implemented method can comprise determining, via the second neural network, an assignment of the process data to an operating state as well as providing a second indicator, which is indicative of the assignment of the process data to the operating state.

The second neural network can be logically or structurally different from the first neural network (for example, the first neural network and the second neural network respectively can have a different depth and/or a different number of nodes per layer).

The second indicator can be provided as a character string, a message or in another suitable manner.

In this way, it is possible for not only determining to enable whether provided process data can be supplied to an (predefined) operating state, but also a subsequent determination can be enabled, in which operating state (of optionally a large number of operating states) the industrial production process is at a particular time interval.

In accordance with a further embodiment, determining can also comprise determining an operating state, at least partially on the basis of a calculation of a metric, which can be assigned to the process data with a predetermined certainty if no unambiguous assignment is possible by providing the process data to the first neural network and/or to the second neural network.

A metric can be taken to be a measure for determining the distance of process data from (at least one) classification group. In some examples, it can be possible to determine a metric distance between process data and at least one predefined classification group. In some cases, it can be possible to plot the captured process data in an at least two-dimensional coordinate system, with it being possible to determine point clouds from the process data. The metric can comprise, for example, determining a metric distance between focal points of the point clouds obtained. It is pointed out that the two-dimensional case described in the present case should only be understood as being illustrative and scenarios in higher dimensions or one-dimension (i.e., generally, n-dimensional) are also possible. In this way, quantitative determination of an operating state can be enabled.

In accordance with yet a further embodiment, providing the second indicator can further comprise providing the second indicator, via a user interface, to a user, as well as determining, at least one next operating state, potentially following the determined operating state, providing the determined at least one potentially following, next operating state to the user, receiving a user input, via the user interface, which is indicative of whether a transition to the following, next operating state should be executed, as well as executing the following, next operating state based on the received user input.

In some cases, the user interface can be provided as a touch-sensitive display (for example, a touchscreen display). Additionally or alternatively, the user interface can comprise an acoustic output means (for example, a loudspeaker) and/or an acoustic input device (for example, a microphone). The user interface can be configured to enable bidirectional communication with a user.

The user input can be received, for example, via a keyboard and/or mouse. Additionally or alternatively, receiving the user input can comprise acoustic receiving (for example, on the basis of a speech input) and/or receiving the user input via the touch-sensitive display.

In some examples, the potentially next operating state can be provided as a single proposal for a potentially next operating state. Alternatively, it can also be possible to provide the potentially next operating state in the context of an offer of a plurality of potentially next operating states. In the latter case, it can be possible that receiving the user input comprises the selection of the desired next operating state.

This can enable an interaction of a user with the computer-implemented method and enable a targeted or desired exertion of influence by the user on the industrial production process. The latter can enable an industrial production process which is tailored to situational circumstances.

In accordance with another embodiment, the computer-implemented method can comprise an analysis of historically executed transitions between two successive operating states as well as determining, at least partially on the basis of the analysis, a prediction of a future expected transition from the determined operating state to a potentially following, next operating state.

Analyzing can comprise analyzing which n^{th} operating state in the past (i.e., historically) followed an n−1^{th} operating state. Analyzing can comprise determining a statistical evaluation that is indicative of with which (relative) frequency in the past a particular n^{th} operating state followed an n−1^{th} operating state. A median value, which was determined over the relevant (relative) frequency, can be indicative of which following, next operating state could most likely follow a current operating state.

In this way, a succession of operating states of a production process of a future production process can be implemented based on historical data. This can enable an improved prediction of a potentially following, next operating state.

The object and advantages are also achieved in accordance with the invention by a computer program product that comprises commands which, when the program is executed by a computer, cause the computer to performed the computer-implemented method in accordance with the disclosed embodiments.

A computer program product, such as a computer program means, can be provided or supplied, for example, as a storage medium, such as a memory card, USB stick, CD-ROM, DVD, or also in the form of a downloadable file from a server in a network. This can occur, for example, in a wireless communications network by transmitting a corresponding file with the computer program product or the computer program means.

The objects and advantages are also achieved in accordance with the invention by a computer-implemented apparatus for determining an operating state of an industrial production process. The computer-implemented apparatus comprises a first provision unit for providing process data, which is associated with the production process, to at least one first trained neural network which was trained as described herein, where the first neural network comprises at least one anomaly identification model and the process data is provided to each of the at least one anomaly identification model. Further, the computer-implemented apparatus comprises a determination unit for determining, at least partially on the basis of the first trained neural network, whether the process data can be assigned to a predefined operating state, as well as a second provision unit for providing a first indicator, which is indicative of whether the process data can be assigned to an operating state.

The respective unit, for example, the first provision unit, the determination unit and/or the second provision unit, can be implemented in terms of hardware and/or also software. With an implementation in terms of hardware, the respective unit can be formed as an apparatus or as part of an apparatus, such as a computer or a microprocessor. With an implementation in terms of software, the respective unit can be formed as a computer program product, as a function, as a routine, as part of a program code or as an executable object.

A neural network can be taken to mean a machine learning computer-based model. It can mimic the mode of operation of the human brain. It can consist, for example, of connected artificial neurons which are arranged in a plurality of layers: an input layer, one or more hidden layer(s) and an output layer. Each neuron can be linked to other neurons and has a specific weighting as well as a threshold value. The neural network can process input data in that it routes it through the various layers, with each layer analyzing and transforming the data. The network can learn to identify patterns and implement tasks, such as classification, prediction or decision-making (as described herein), via a training process (for example, as described herein) with large volumes of data. The ability of the neural network to model complex non-linear relationships between input and output data can enable it to perform generalizations and react to new unknown inputs.

In accordance with an embodiment, the computer-implemented apparatus can also comprise an execution unit for executing the steps of the computer-implemented method as described herein and/or a further execution unit for executing the computer program product as described herein.

The execution unit and/or the further execution unit can comprise a Field Programmable Gate Array (FPGA) and/or a central processing unit (CPU) and/or another suitable calculation unit.

The objects and advantages are further achieved in accordance with the invention by a system for determining an operating state of an industrial production process. The system comprises the computer-implemented apparatus as described herein and the computer program product as described herein.

In some examples, a computer-implemented apparatus for training a first neural network can be provided to identify an operating state of an industrial production process. The apparatus comprises a definition unit for defining the at least one operating state, a determination unit for determining at least one time interval in which the industrial production process finds itself in the operating state that is to be identified, a provision unit for providing a first assignment of process data, which is associated with the production process, for the operating state which is to be identified and which is active during the time interval as well as a training unit for training, based on the provided first assignment, a first neural network, where the first neural network comprises at least one anomaly identification model and wherein the neural network is trained, based on the at least one anomaly identification model, to perform an assignment of process data, which is associated with the production process, to an operating state which is active at a particular time interval.

Further, a trained first and/or a trained second neural network can be provided that was trained as described herein.

Even if the embodiments described herein were described in isolation from one another, it is nevertheless pointed out that these can also be arbitrarily combined with one another independently thereof.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

Further advantageous embodiments and aspects of the invention are the subject matter of the sub-claims as well as the exemplary embodiments of the invention described below. Hereafter the invention will be explained in more detail on the basis of preferred embodiments with reference to the attached Figures, in which:

FIG. 1 shows an exemplary method for determining an operating state;

FIG. 2 shows a flowchart of an exemplary computer-implemented method for training a first neural network;

FIG. 3 shows an exemplary computer-implemented method for determining an operating state of an industrial production process;

FIG. 4 shows a computer-implemented apparatus for determining an operating state of an industrial production process; and

FIG. 5 shows an exemplary system for determining an operating state of an industrial production process.

### DETAILED DESCRIPTION OF THE EXEMPLARY EMBODIMENTS

Identical or functionally identical elements are provided with the same reference numerals in the Figures unless stated otherwise.

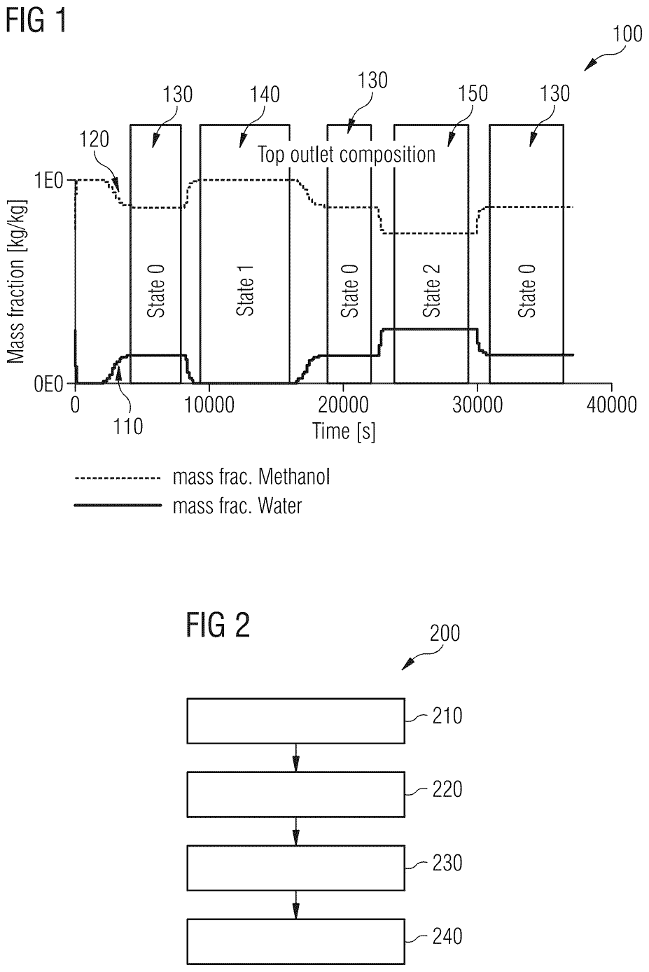

FIG. 1 shows a graph 100 that illustrate an exemplary method for determining an operating state of an industrial production process.

Graph 100 shows an exemplary output rate for water 110 as well as an exemplary output rate for methanol 120 (in kg/kg respectively) as can be applied within the context of an exemplary industrial production process.

These exemplary mass flows can serve as process data respectively in order to determine an operating state of an industrial production process.

For this, it can be possible to capture specific manifestations, such as measurement data (sensor data), which can then serve as process data.

In some cases, it can be possible to associate the obtained measurement data with operating states because the existence of specific manifestations are assigned to respective operating states. These operating states, which are to be determined, such as within the context of the method presented herein, can in some cases be defined in advance by a user of the computer-implemented method.

A prior definition of this kind can comprise, for example, defining at least one time interval during which specific manifestations of process data are to be considered and optionally should be associated with an operating state defined in advance.

A first neural network can subsequently be trained to identify at least one operating state, based on process data provided for a time interval (as described herein). The first neural network can in some cases comprise a State Vector Machine (SVM) and/or an Isolation Forest (IF), which were trained in advance respectively (as described herein).

In one example, the presence of a first manifestation of the mass flow for water 110, such as the presence of a manifestation (for example, a first measured value) of the mass flow for methanol, can be associated with a first operating state 130. In some cases, a first trained neural network can be used to determine whether the configuration of first manifestations respectively can actually be associated with an operating state, i.e., whether a corresponding operating state was defined in advance. This can occur, for example, based on the IF. The IF can be used, for example, to be able to determine undefined operating states or outliers. It is possible to determine defined operating states via the SVM.

The first manifestation of the mass flow for water 110 can change over time and, for example, decrease to a second manifestation of the mass flow for water 110.

Simultaneously (i.e., during an identical (user-defined) time interval), the first manifestation of the mass flow for methanol 120 can also increase from the first manifestation in the direction of a second manifestation. The existence of this configuration of the second manifestation of the mass flow for water 110 as well as the second manifestation of the mass flow for methanol 120 can be associated with the existence of a second operating state 140.

Over the further course of time the mass flow for water 110 can increase, for example, from the second manifestation in the direction of the first manifestation. Similarly, it is possible for the mass flow for ethanol 120 to also decrease from the second manifestation back in the direction of the first manifestation in the period being considered. The resulting configuration of the respective manifestations of the mass flow for water 110 and of the mass flow for ethanol 120 corresponds to the configuration of the first operating state 130 that was described above.

Over the further course of time, it is possible for the mass flow for water 110 to increase from the first manifestation in the direction of a third manifestation, with it being possible for the third manifestation to be higher than the first manifestation and than the second manifestation of the mass flow for water 110. In the same time interval associated therewith, it is possible for the mass flow for methanol 120 to decrease from the manifestation in the direction of a third manifestation, with the third manifestation being smaller than the first manifestation and than the second manifestation.

The existence of this configuration of third manifestation of the mass flow for water 110 and the third manifestation of the mass flow for methanol 120 can be associated with the existence of a third operating state 150.

Over the further course of time, it is possible for the mass flow for water 110 to decrease from the third manifestation back in the direction of the first manifestation. Further, it is possible, in the time interval associated therewith, for the third manifestation of the mass flow for methanol 120 to also increase from the third manifestation back in the direction of the first manifestation. The resulting configuration can be associated again with the existence of the first operating state 130.

In accordance with some aspects, it can also be possible to trigger and/or select an operating state transition (for example, based on a predetermined selection of possible following, next operating states).

The relevant following, next operating state can be provided, for example, based on a user interface. The user interface can provide, for example, a visual representation of the operating states, transitions and other relevant items of information. This can further increase the user-friendliness of monitoring an operating state or the selection of an operating state. The interface can be configured intuitively, in particular, and this can minimize an optionally necessary training period for the relevant user and can consequently increase the efficiency of a user. Further, the risk of errors which may potentially occur can be reduced in this way.

A following, next operating state can be selected, for example, based on a user assistance system.

In some cases, real-time monitoring of the industrial production process can be provided. In a case of this kind a system (for example, the system as described herein) can continuously monitor the process in real-time and thereby determine the current operating state and keep its course up-to-date. This can make it possible for a user to always be provided with up-to-date items of information (for example, an up-to-date operating state) about the industrial production process.

Further, a transition management can be provided. The system can not only display possible transitions between states, but can also initiate the actual transition and an execution of the respective subsequent, next operating state. The transition management can enable the user, in particular, to trigger transitions and perform other actions in order to transfer the industrial production process from a current operating state to a next following operating state (or to a target state).

Further, an operating state determination can be provided. In a case of this kind, the system can provide algorithms (for example, based on machine learning) in order to determine a current operating state. This can minimize manual efforts and errors that potentially occur as a result, which can be associated, for example, with determining a current operating state.

In some cases, it is not (unambiguously) possible to determine an operating state. In a case of this kind, it can be possible to identify a next, appropriate (defined, i.e., an operating state that would be identified by the first neural network) operating state or to determine a metric (for example, a distance metric) for a defined operating state. Based on the specific metric, it can be possible to select a defined operating state which is most similar to captured data. The information thus obtained can support a user in determining and optionally characterizing an up-to-date operating state of the industrial production process.

In some cases, management or decision-making support can be provided. In this way, by highlighting, possible transitions from a current operating state to a target operating state, can occur for a user. This can be helpful to the user in making informed decisions and, based on the available items of information, determining an appropriate target operating state. In some cases, it can also be possible that an automatic transition from a current operating state to a following, next operating state is automatically initiated (for example, by the system and/or a suitable apparatus). In some cases, the transition can be initiated based on algorithms.

In some cases, a performance prediction can be provided. An expected state of the process can be predicted based on executed transitions. This can enable a user to obtain more targeted items of information about a system behavior of a system, which is associated with the industrial production process, to make appropriate decisions. This can improve the general efficiency and performance of the system.

In some cases, an integration and automation technology can be provided. The aspects presented herein can be provided such that they can be seamlessly embedded in an existing control environment, such as a Distributed Control system (DCS) via of protocols, such as open Platform Communications (OPC). This can enable the system to interact with a logically deeper control system and optionally trigger necessary actions which can be significant for a change in an operating state. In some cases, direct communication (for example, by the system and/or a corresponding apparatus (as described herein)) and actuators or sensors can be enabled without communication via an automation technology. This can further improve the functionality and effectiveness and provide the users with a seamless and efficient workflow.

In some cases, the system described herein or the apparatus described herein can be configured to manipulate features of connected automation technologies, such as a threshold value for an alarm and events in the DCS or user rights in the DCS, based on a current, identified operating state.

The system can be connected to procedural guidelines or related documents (for example, standard operating procedures), which are associated with specific process states and can supply the user with items of information in respect of a specific operating state. Further, this can make it possible for a user to be provided with detailed items of metainformation or context information.

The advantages of aspects of the present invention can be seen, for example, in the aspects described below:
Increased efficiency for the operator: the comprehensive support, the integration with the DCS and the user-friendly interface can rationalize the workflow of the operator and reduce the amount of time and work expended for the method-based process condition. This can result in increased productivity and efficiency.
Increased accuracy: the state identification, the identification of the next state and the prediction functions can minimize errors and improve the accuracy of the process cycles. The operators can rely on the instructions and items of information of the system, whereby the risk of errors can be reduced and a reliable process execution can be guaranteed. In the case of an abnormal situation, the system can support the operator in bringing the system into a normal/defined/safe operating state.
Improved decision-making: the guidance, the decision-making support and the visualization of possible transitions can empower the operator to make informed decisions when selecting target states and initiating transitions. This can contribute to improved decision-making and optimized process control.
Reduced training requirements: the intuitive user interface and the automated functions of the system can reduce the need for training for the operators. They can quickly familiarize themselves with the system and effectively navigate through state-based procedural cycles.

In some cases, for example in the context of a further embodiment, which can be combined with the first embodiment, as described herein, a first neural network can be trained, where the trained first neural network can subsequently be used to identify an operating state of an industrial production process.

Training can comprise defining at least one operating state of an industrial production process. The at least one operating state can be associated, for example, with the production of a product A or an initial operating state of the industrial production process.

Subsequently, at least one time interval can be defined (for example, for each of the at least one operating state) which describes specific time periods during which the industrial production process is in a specific operating state.

Further, an at least two-stage training process can be applied. In this connection, a first neural network can be trained in a first step (as described herein), in order to identify outliers (i.e., anomalies) or new features, which the training data did not include, in the trained first neural network. This can be based on all available time intervals respectively. This can occur, for example, by using Isolation Forest or one-class support vector machines. In some examples, the first neural network can also comprise at least one anomaly identification model which was trained for all time intervals of the available process data.

A second neural network can be trained in a second step (as described herein). The second neural network, if it was trained, can be used to assign a defined operating state to a predefined class of operating states by using a classification model (for example, a support vector machine). The second neural network can also comprise at least one anomaly identification model that was trained for a specific operating state. In a case of this kind, for example, the at least one anomaly identification model for a specific operating state, for which it was trained, can regard the operating state as anomaly-free. In all other cases, the trained at least one anomaly identification model can identify an operating state (for which the anomaly identification model was not trained) as having an anomaly.

The model can be previously trained using data from selected time intervals that describe the defined states of the industrial production process.

The first trained neural network and the second trained neural network can subsequently be used to determine at least one operating state of the industrial production process. In this connection, it can firstly be provided that it is determined, via the trained first neural network, whether captured process data can, in principle, be assigned to an operating state (as described herein). If the trained first neural network establishes that this is not possible, then it returns a first indicator that can be indicative of either an unknown state existing or an assignment not being unambiguously possible. This can then be given, for example, if the at least one anomaly identification model identifies an anomaly.

If the captured process data is not assigned to an unknown or non-ambiguously determinable operating state, then the second trained neural network can be used to determine a specific operating state to which the captured process data can be assigned. If at least one anomaly identification model is used for determining to which specific operating state captured process data can be assigned, then the “sought” operating state is the operating state that is associated with the anomaly identification model that does not output an anomaly for the captured process data. If a plurality of anomaly identification models identify the process data as anomaly-free, then the captured process data cannot be unambiguously assigned to an operating state.

In an alternative embodiment, which can be combined with the first and/or second embodiment (as described herein), identifying the at least one operating state can be understood as a soft sensor model. The target value can be a defined operating state. The soft sensor can train the operating state and the uncertainty of the prediction.

The soft sensor can predict the operating state during the runtime. If the industrial production process is in an unknown state, the uncertainties can be a measure of how far/how close the actual state expressed by the process data is from/to a known operating state.

In particular, the aspects presented herein can enable a state-based process operation in accordance with the ISA-88 and ISA-106 standards and thus enable compatibility and the adherence to industry regulations. This can facilitate safety and certainty for the users during the industrial production process.

FIG. 2 shows a flowchart of an exemplary computer-implemented method 200 for training a first neural network to identify an operating state of an industrial production process.

The at least one operating state is defined in step 210.

At least one time interval is determined in step 220, in which interval the industrial production process finds itself in the operating state that is to be identified.

A first assignment of process data is provided in step 230, which data is associated with the production process, for the operating state that is to be identified and which is active during the time interval.

A first neural network is trained, based on the provided first assignment in step 240, with the first neural network comprising at least one anomaly identification model and with the neural network being trained, based on the at least one anomaly identification model, to perform an assignment of process data, which is associated with the production process, for an operating state which is active at a particular time interval.

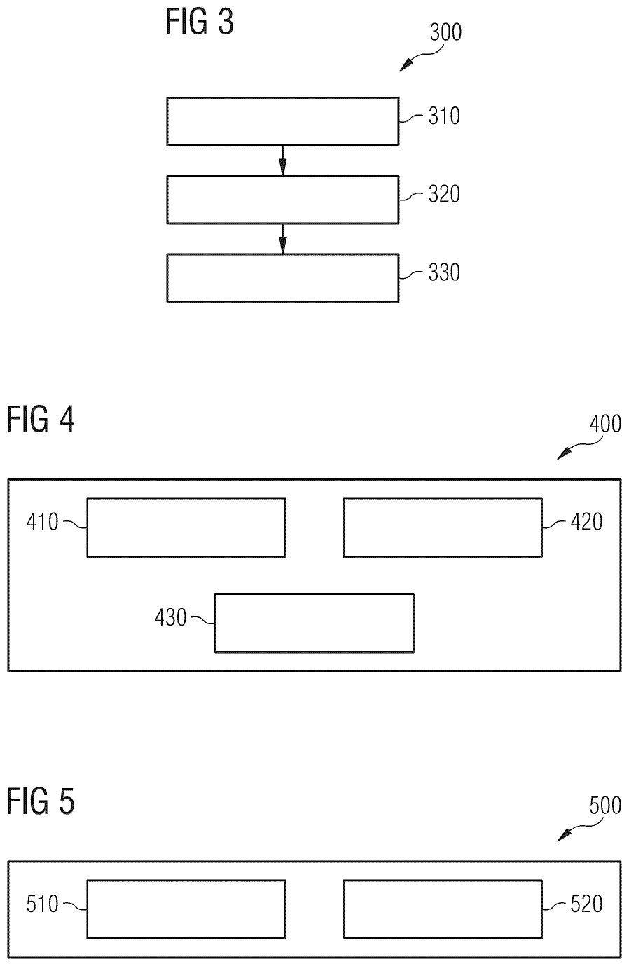

FIG. 3 shows an exemplary computer-implemented method 300 for determining an operating state of an industrial production process.

Process data, which is associated with the production process, is provided in step 310 to at least one first trained neural network, which was trained as described herein, with the first neural network comprising at least one anomaly identification model and the process data being provided to each of the at least one anomaly identification model.

In step 320 it is determined, at least partially based on the first trained neural network, whether the process data can be assigned to a predefined operating state.

A first indicator is provided in step 330, which indicator is indicative of whether the process data can be assigned to an operating state.

FIG. 4 shows an exemplary computer-implemented apparatus 400 for determining an operating state of an industrial production process. The computer-implemented apparatus 400 comprises a first provision unit 410, a determination unit 420 as well as a second provision unit 430.

The first provision unit 410 is configured to provide process data, which is associated with the production process, to at least one first trained neural network, which was trained as described herein, with the first neural network comprising at least one anomaly identification model and the process data being provided to each of the at least one anomaly identification model.

The determination unit 420 is configured to determine, at least partially based on the first trained neural network, whether the process data can be assigned to a predefined operating state.

The second provision unit 430 is configured to provide a first indicator, which is indicative of whether the process data can be assigned to an operating state.

FIG. 5 shows an exemplary system 500 for determining an operating state of an industrial production process. The system comprises a computer-implemented apparatus 510 as well as a computer program product 520.

The computer-implemented apparatus 510 can be provided in a manner similar to the computer-implemented apparatus as described herein.

The computer program product 520 can be provided as described herein.

Although the present invention was described on the basis of exemplary embodiments, it can be modified in various ways.

The neural networks mentioned are, in particular, artificial neural networks which are computer-implemented.

Thus, while there have been shown, described and pointed out fundamental novel features of the invention as applied to a preferred embodiment thereof, it will be understood that various omissions and substitutions and changes in the form and details of the methods described and the devices illustrated, and in their operation, may be made by those skilled in the art without departing from the spirit of the invention. For example, it is expressly intended that all combinations of those elements and/or method steps that perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is

1. A computer-implemented method for training a first neural network to identify an operating state of an industrial production process, the method comprising:
defining the at least one operating state;
determining at least one time interval in which the industrial production process finds itself in the operating state which is to be identified;
providing a first assignment of process data which is associated with the production process, for the operating state which is to be identified, which is active during the time interval; and
training, based on the provided first assignment, a first neural network;
wherein the first neural network comprises at least one anomaly identification model; and
wherein the neural network is trained, based on the at least one anomaly identification model, to perform an assignment of process data, which is associated with the production process, for an operating state which is active at a particular time interval.

2. The computer-implemented method as claimed in claim 1, wherein the operating state is associated with the production of a particular product or with an initial operating state.

3. The computer-implemented method as claimed in claim 1, wherein for each operating state which is to be identified, the first neural network comprises one anomaly identification model respectively and each operating state which is to be identified is associated with one anomaly identification model respectively which identifies the operating state which is to be identified as anomaly-free.

4. The computer-implemented method as claimed in claim 2, wherein for each operating state which is to be identified, the first neural network comprises one anomaly identification model respectively and each operating state which is to be identified is associated with one anomaly identification model respectively which identifies the operating state which is to be identified as anomaly-free.

5. The computer-implemented method as claimed in claim 3, wherein the training further comprises training each anomaly identification model, such that each anomaly identification model identifies the operating state respectively assigned to it as anomaly-free and identifies other operating states different from the assigned operating state as having an anomaly.

6. The computer-implemented method as claimed in one of claim 1, further comprising:
providing a second neural network, which comprises a classifier, with a second assignment of process data for one operating state respectively; and
training, based on the provided second assignment, the second neural network;
wherein the second neural network is trained to assign process data to an operating state.

7. The computer-implemented method (300) for determining an operating state of an industrial production process, further comprising:
providing process data, which is associated with the production process, to at least one first trained neural network, which was trained as claimed in claim 1, the first neural network comprising at least one anomaly identification model and the process data is provided to each at least one anomaly identification model;
determining, at least partially on the basis of the first trained neural network, whether the process data is assignable to a predefined operating state; and
providing a first indicator, which is indicative of whether the process data is assignable to an operating state.

8. The computer-implemented method as claimed in claim 7, wherein said determining whether the process data is assignable to one of the operating states further comprises:
determining that the process data cannot be assigned to any of the operating states if each of the at least one anomaly identification model identifies the process data as having an anomaly; or
determining that the process data is assignable to one of the operating states if one of the at least one anomaly identification model identifies the process data as anomaly-free; or
determining that the process data cannot be assigned to any of the operating states if more than one anomaly identification model is provided and if at least two anomaly identification models identify the process data as anomaly-free.

9. The computer-implemented method as claimed in claim 7, further comprising:
providing the process data if the process data could be assigned to an operating state, to a second neural network, comprising the trained classifier;
determining, via the second neural network, an assignment of the process data to an operating state; and
providing a second indicator, which is indicative of the assignment of the process data to the operating state.

10. The computer-implemented method as claimed in claim 8, further comprising:
providing the process data if the process data could be assigned to an operating state, to a second neural network, comprising the trained classifier;
determining, via the second neural network, an assignment of the process data to an operating state; and
providing a second indicator, which is indicative of the assignment of the process data to the operating state.

11. The computer-implemented method as claimed in claim 1, wherein said determining further comprises:
determining an operating state, at least partially on the basis of a calculation of a metric, to which the process data is assignable with a predetermined certainty if no explicit assignment is possible by providing the process data to at least one of the first neural network and the second neural network.

12. The computer-implemented method as claimed in claim 7, wherein providing the second indicator further comprises:
providing, via a user interface, the second indicator to a user;
determining at least one potentially next operating state which follows the determined operating state;
providing the determined at least one potentially following, next operating state to the user;
receiving, via the user interface a user input which is indicative of whether the following, next operating state should be executed; and
executing a transition to the following, next operating state based on the received user input.

13. The computer-implemented method as claimed in claim 12, further comprising:
analyzing historically executed transitions between two successive operating states; and
determining, at least partially based on the analyzing, a prediction of a transition, which is to be expected in the future, from the determined operating state to a potentially following, next operating state.

14. A computer program product, comprising commands which, when the program is executed by a computer, cause the computer to perform the steps of the computer-implemented method as claimed in claim 1.

15. A computer-implemented apparatus for determining an operating state of an industrial production process, comprising:
a first provision unit for providing process data, which is associated with the production process, to at least one first trained neural network, the first neural network comprising at least one anomaly identification model and the process data being provided to each at least one anomaly identification model;
a determination unit for determining, at least partially based on the first trained neural network, whether the process data is assignable to a predefined operating state; and
a second provision unit for providing a first indicator which is indicative of whether the process data is assignable to an operating state.

16. The computer-implemented apparatus as claimed in claim 15, further comprising:
an execution unit; and
a further execution unit.

17. A system for determining an operating state of an industrial production process, comprising:
the computer-implemented apparatus as claimed in claim 15; and
a computer program product, comprising commands which, when the program is executed by a computer, cause the computer to perform the steps of the computer-implemented method.
